(19) United States
(12) Patent Application Publication
(10) Pub. No.: US 2013/0235211 A1
(43) Pub. Date: Sep. 12, 2013

(54) Multifunctional Bispectral Imaging Method and Device

(71) Applicant: Jean-Claude Fontanella, Gif Sur Yvette (FR)

(72) Inventor: Jean-Claude Fontanella, Gif Sur Yvette (FR)

(73) Assignee: THALES, Neuilly Sur Seine (FR)

(21) Appl. No.: 13/810,079

(22) PCT Filed: Jul. 13, 2011
(86) PCT No.: PCT/FR2011/051674

§ 371 Date: May 24, 2013

(30) Foreign Application Priority Data
Jul. 13, 2010 (FR) 1002957

(51) Int. Cl. G06K 9/32

(52) U.S. Cl. CPC G06K 9/3241
USPC 348/169; 382/103

(57) ABSTRACT

A multifunctional device and method for bispectral imaging are provided. The device and method include acquiring a plurality of bispectral images (IBM), each bispectral image being the combination of two acquired images (I_{M1}, 1_{M2}) in two different spectral bands, and generating a plurality of images, each of which gives an impression of depth by combining the two acquired images (I_{M1}, 1_{M2}) and forming imaging information. The method includes simultaneously processing the plurality of bispectral images in order to generate, in addition to the imaging information, watch information and/or early threat information, comprising the following steps: searching for specific spectrum and time signatures, associated with a particular threat, in the plurality of bispectral images; and detecting a specific object in each bispectral image, and generating a time-tracking of the position of the object in the plurality of images in each spectral band, and the detecting and the tracking of the object forming the watch information.

The present invention relates to a multifunctional bispectral imaging method, comprising a step of acquiring a plurality of bispectral images, each bispectral image being the combination of two images acquired in two different spectral bands, and a step of generating a plurality of images, each of which gives an impression of depth by combining the two acquired images and forming imaging information. The invention also relates to an imaging device implementing the imaging method.

### BACKGROUND OF THE INVENTION

A bispectral device is a device making it possible to acquire an image in two spectral bands, for example the 3-5 μm and 8-12 μm spectral bands. One particular case is that of bicolor devices that use two sub-bands of a same primary spectral band. For example, for the band between 3 and 5 μm, certain infrared bicolor devices acquire one image in the sub-band from 3.4 to 4.2 μm and another image in the sub-band from 4.5 to 5 μm.

The invention applies to the field of detection optoelectronics and panoramic viewing systems. These systems in particular equip aerial platforms (transport planes, combat planes, drones and helicopters), maritime platforms, and land-based platforms (armored vehicles, troop transport, etc.) designed for surveillance and/or combat. Such platforms need multiple pieces of information.

For example, they need to establish the tactical situation, i.e., to know the position of other operators (aerial and/or land platforms) on a battlefield so as subsequently to be able to develop a combat strategy.

It is also useful to have information, such as a very wide field and high resolution image, for example, to help with the steering or navigation of the platforms.

Furthermore, on a battlefield, it is important to be able to detect what is called an early threat and to identify the type of threat, for example, a missile, heavy arm (cannon), or shot.

To obtain all of this information, special devices are required with sensors and suitable processing units.

For example, patent EP 0 759 674 describes a method for giving the impression of depth in an image, which is very useful information for the pilot of an aerial platform, for example. The patent also describes a camera designed to implement this method so as to provide an image giving the impression of depth. This camera is a bispectral camera, i.e., adapted to provide two images in two different bispectral bands in the infrared. The image giving the impression of depth is obtained by combining two images acquired in the two spectral bands.

Another example: the DAIRS (“Distributed Aperture InfraRed Systems”) system developed by Northrop Grumman for the “Joint Strike Fighter” (JSF) airplane is a mono-spectral imaging device, i.e., making it possible to acquire an image in a single spectral band. The system consequently delivers imaging information. Nevertheless, it does not give an impression of depth obtained using bispectral or bicolor systems. Furthermore, the system is not capable of detecting a very short event, such as an early threat such as a shot.

Furthermore, devices may exist comprising several multispectral systems so as for example to provide imaging depth information or detect an early threat. Nevertheless, the multiplicity of this type of device leads in particular to a very high complexity, and therefore very high cost for integration into the platform and very high equipment costs.

### SUMMARY OF THE INVENTION

An object of the invention is to provide an imaging method and device that are less bulky, easier to integrate, and generally less expensive than a set of mono-functional devices for platforms such as surveillance or combat platforms.

To present invention provides an imaging method of the aforementioned type, characterized in that it comprises a step of simultaneous processing of the plurality of bispectral images to generate, in addition to the imaging information, watch information and/or early threat information, comprising the following steps:
searching for specific spectrum and time signatures in the plurality of bispectral images, a particular spectral and time signature being associated with a particular threat; and
detecting a specific object in each bispectral image, and generating a time-tracking of the position of the object in the plurality of images in each spectral band, and the detecting and the tracking of the object forming the watch information.

According to specific embodiments, the imaging method may include one or more of the following features:
the two bands belong to a same infrared spectral band whereof the wavelength is comprised between 3 and 5 μm and are each situated on either side of a wavelength substantially equal to 4.3 μm;
the step of acquiring a plurality of bispectral images is carried out at a high frequency, at least substantially equal to 400 Hz;
the step of acquiring a plurality of bispectral images comprises a micro-sweeping step to generate a plurality of higher resolution bispectral images;
it comprises a step of combining a plurality of pixels of each higher resolution bispectral image to reduce the number of pixels and improves the signal-to-noise ratio before the step of searching for particular spectral and time signatures in the plurality of higher resolution bispectral images;
the plurality of bispectral images is acquired by at least two cameras that are time synced beforehand.

The invention also provides an imaging device including at least one bispectral camera, each including a bispectral matrix of a plurality of detectors capable of acquiring a plurality of bispectral images, each bispectral image being the combination of two images acquired in two different spectral bands, the imaging device comprising means for generating a plurality of images each giving an impression of depth from the two images acquired in the two different bands, the plurality of images being imaging information and the device being characterized in that it comprises means for simultaneous processing operations of the plurality of bispectral images to generate at least two pieces of information from amongst watch information, early threat information, and imaging information, the means for simultaneous processing being connected to the at least one bispectral camera and comprising:
the means for generating the imaging information;
means for searching for particular spectral and time signals from the plurality of bispectral images, a particular spectral and time signature being associated with a particular threat; and
means for detecting a particular object on each bispectral image and generating a time-tracking of the position of the object on the plurality of images in each spectral band, the detection and tracking of the object forming the watch information.

According to specific embodiments, the imaging device may include one or more of the following features:
the two bands belong to a same infrared spectral band whereof the wavelength is comprised between 3 and 5 μm and are each situated on either side of a wavelength substantially equal to 4.3 μm;
it is adapted to carry out the preceding method.

### BRIEF DESCRIPTION OF THE DRAWINGS

The invention will be better understood upon reading the following description, provided solely as an example, and done in reference to the drawings, in which:

FIG. 1 is an overview diagram of an embodiment of an imaging device according to the invention comprising a plurality of bispectral cameras;

FIG. 2 is an overview diagram of one embodiment of an imaging device according to the invention comprising a bispectral camera;

FIG. 3 is a block diagram illustrating an imaging and processing method implemented by the imaging device according to the invention,

FIG. 4 is an overview diagram of a bispectral mega-image according to the invention,

FIG. 5 is a graph showing the atmospheric transmission, over short and long distances, in the infrared band comprised between 3 and 5 μm whereof the central wavelength is 4.3 μm,

FIG. 6 is a graph showing the optical flow in the infrared band whereof the wavelength is comprised between 3 and 5 μm, for a missile jet, the ground, and solar radiation,

FIGS. 7 and 8 are overview diagrams illustrating the notions of spectral and time signatures of an object detected by the imaging device according to the invention,

FIG. 9 is an overview diagram of another embodiment of an imaging device according to the invention including a bispectral camera,

FIG. 10 is an overview diagram illustrating the principle of micro-sweeping of a bispectral camera, and

FIG. 11 is a block diagram illustrating another embodiment of the imaging method according to the invention.

### DETAILED DESCRIPTION

The present invention provides an imaging device designed to be integrated into an aerial or land platform such as an airplane, helicopter, drone, armored vehicle, etc. This type of platform is designed for surveillance and/or combat. It makes it possible, during the day and night, and in real-time, to acquire and process images, for example so as to effectively coordinate the auto-defense maneuvers of the platform or to help steer the platform.

The same device is capable of making it possible to provide an operator with:
imaging information, i.e., an image that a person in the considered zone can interpret,
watch information, i.e., an image showing potential targets and their positions, for example people, a tank, another platform, etc., and
early threat information, i.e., an image in which an early threat is clearly identified and positioned, for example a shot, missile fire, or cannon fire.

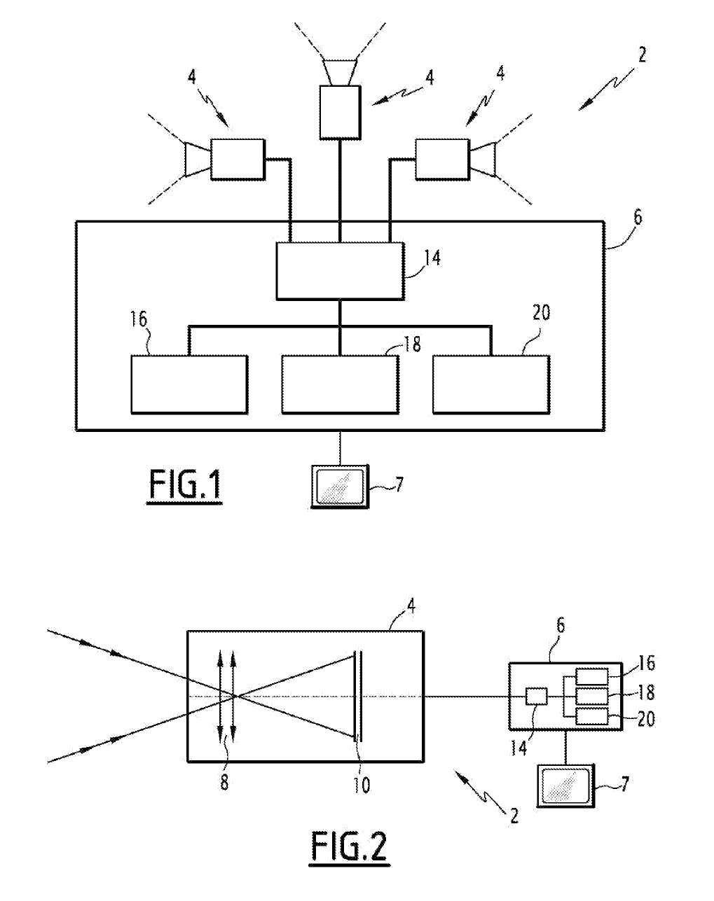

FIG. 1 illustrates a device 2 according to the invention that includes at least one bispectral camera 4, processing means, for example, a processor 6, and a man-machine interface such as a screen 7. The processing means 6 are connected on the one hand to the or each bispectral camera 4 and on the other hand to the screen. The screen is designed to display the information processed by the processing means 6.

Of course, any number of bispectral cameras may be considered, three being shown in this figure. The principle of the bispectral cameras is identical and will be described in detail below. For example, they may differ in terms of resolution (number of pixels of the detector of the cameras), their focal distance, and the field of the optics.

Each camera looks, i.e., is oriented, in a different average direction from the others. The viewing fields of each camera may be completely separate, but while avoiding having areas that are not covered, or may have an overlapping portion so as to obtain and/or reconstruct an image having a continuous field of vision going from one camera to the next. In this way, the plurality of bicolor cameras covers all or part of the space.

For example, a so-called frontal camera, because it is placed at the front of the aerial platform such as a helicopter, is designed to image the space located in front of the platform, while two side cameras, which are situated on the flanks of the platform, are each capable of looking in a direction substantially perpendicular to that of the frontal camera. Furthermore, the frontal camera generally has a better spatial resolution than the side cameras.

The processing means 6 include means 14 for shaping the signals generated by each bicolor camera 4 connected to means 16 for generating watch information, means 18 for generating threat information, and means 20 for generating imaging information for steering or navigation.

Of course, the signal generated by each camera is representative of the image acquired by that camera. Hereafter, processing of an image indicates processing of the signal associated with the image acquired by the camera, the image being converted into a signal by the camera.

The means 14 for shaping the signals comprise means for synchronizing all of the signals delivered by a plurality M of bispectral cameras 4 of the imaging device 2 and means for generating a so-called bispectral mega-image formed by combining the set of bispectral images acquired by the cameras of the device at the same moment.

The means 16 for generating watch information include means for processing the bispectral mega-image capable of detecting and identifying at least one target by its radiometric and/or spectral signature and generating tracking of those targets.

In a known manner, a target is a hotspot, i.e., it gives off heat relative to its environment: a person, equipment, a moving platform, etc.

Furthermore, a spectral signature of an object is the dependence of a set of characteristics of the electromagnetic radiation of the object with the wavelength, which contributes to identifying the object, for example its relative light emission, the intensity between two spectral bands, its maximum emission wavelength, etc.

The radiometric signature of a target is defined by the intensity radiated by that target relative to its environment, in a known manner called the background image.

Likewise, the means 18 for generating threat information include means for searching for a spectral signature representative of a potential threat in the same bispectral mega-image.

They also comprise means for searching for a time signal of that potential threat and discriminating the type of threat, for example by comparing with a data bank, so as to confirm that it is indeed a threat and what type of threat it is.

By definition, a time signature of a threat is the characteristic emission time of the threat. For example, a shot will be much shorter than the jet of a missile, and may repeat rapidly (for example, a burst from a small arm).

The means 20 for generating imaging information for steering or navigation purposes comprise means for generating an image with an impression of depth as described in patent EP 0 759 674, hereby incorporated by reference herein.

The bispectral cameras 4 will now be outlined in light of FIG. 2, which illustrates an imaging device only comprising a single camera so as not to overload the figure.

The bispectral camera 4 is a wide field camera making it possible to cover part of the space to be analyzed. It comprises at least one wide field optical system 8 and a detector 10. Such a camera is for example described in patent EP 0 759 674.

Such a wide field optical system 8 has already been described, for example in patent FR 2 692 369, hereby incorporated by reference herein. Preferably, the field of the lens 8 is substantially comprised between 60° and 90°.

The detector 10 is a bispectral detector, for example as described in patent EP 0 759 674, which includes a bispectral matrix, for example of the multiple quantum well or super-network type, in particular making it possible to deliver signals in two sub-bands of a same spectral band or in two different spectral bands. In the first case, the detector is said to be bicolor. The size of the bispectral matrix is substantially at least 640 pixels×480 pixels.

Preferably, the dimensions of the matrix are 1000×1000 pixels, corresponding to an elementary field of 1.57 mrad, or 500×500 pixels, corresponding to an elementary field of 3.14 mrad.

Furthermore, the acquisition frequency of the bispectral camera 4 is high, and preferably at least 400 Hz.

The camera simultaneously acquires two images of the same field of vision of the space: one in each spectral band.

To that end, the lens 8 focuses the light flow on the bispectral detector 10, which converts it into an electrical signal transmitted to the processing means 6.

Furthermore, the two spectral bands in which the bispectral camera 2 is sensitive are such that they have particular characteristics, in particular regarding the electromagnetic emission of missile jets and the variation of the atmospheric transmission as a function of distance.

For example and preferably, the spectral band is situated in the infrared and its wavelength is comprised between 3 and 5 μm. The two sub-bands are situated on either side of a wavelength substantially equal to 4.3 μm. The first sub-band has a wavelengths substantially comprised between 3.4 and 4.2 μm, and the second has a wavelength substantially comprised between 4.5 and 5 μm.

In a known manner, the red or hot band is defined as the spectral sub-band whereof the wavelengths are largest relative to those of the second spectral sub-band, called the blue or cold band.

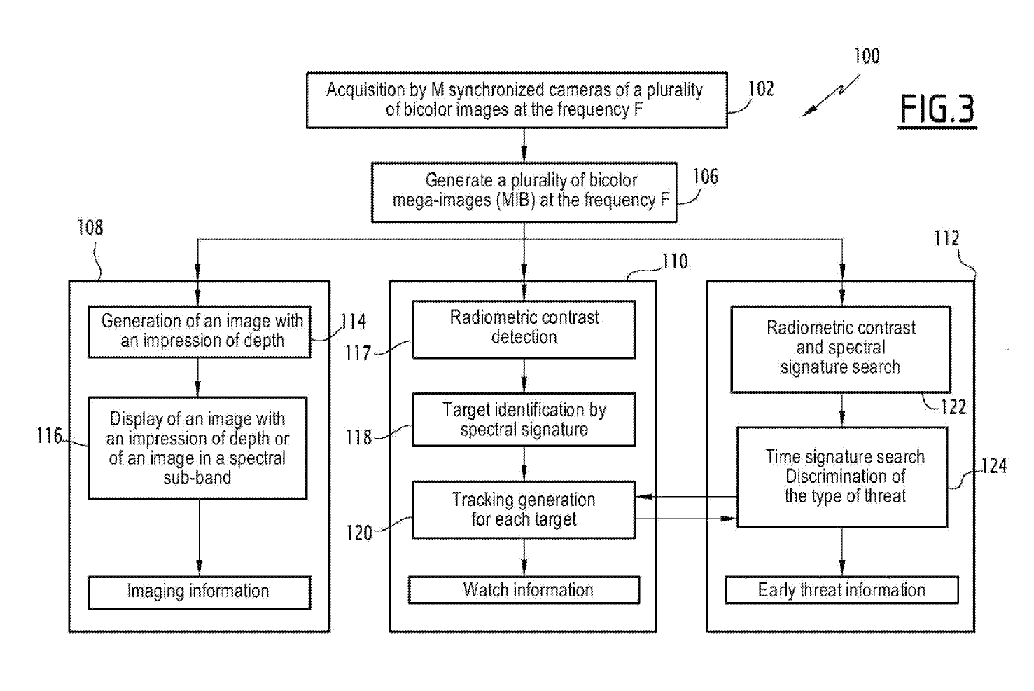

The imaging device according to the invention implements the imaging method 100, which will now be described in light of FIG. 3.

Each bispectral camera 4 of the imaging device 2 requires a plurality of bispectral images denoted IB_{M}, where M is the number of the camera, during a step 102 for acquiring a plurality of bispectral images of the method 100.

The acquisition is done at a high frequency F, preferably substantially equal to 400 Hz.

Each image of a sub-band I_{M1}, I_{M2} has a dimension of L pixels×H pixels (the dimensions of the bispectral matrix of the camera), or N pixels in all (N=L×H).

Each pair of images I_{M1}, I_{M2} is then combined to form a bispectral image IB_{M} of 2×L×H, for example by juxtaposing them.

In a known manner, the M cameras (for M≧1) are synchronized by construction before acquiring the bispectral images. For example, they use a shared clock.

Then, these means 14 combine the M bispectral images of the cameras to form a bispectral mega-image MIB during the step 106 for generating a bispectral mega-image.

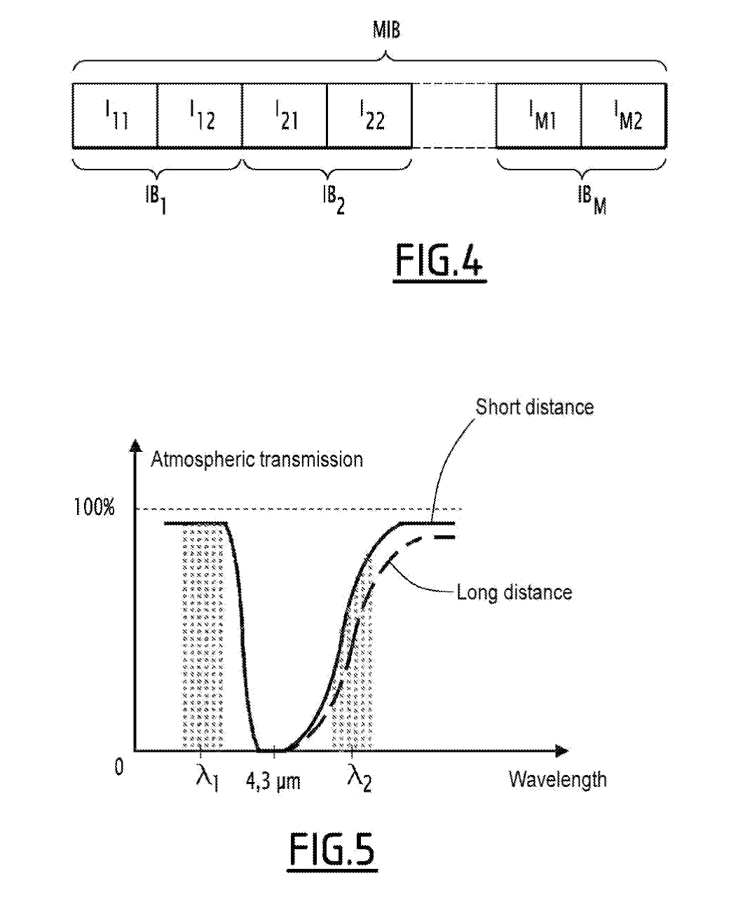

For example, the bispectral mega-image MIB is generated by juxtaposing the bispectral images IB_{M} of each camera, as shown in FIG. 4.

In this way, a plurality of bispectral mega-images is obtained at the same acquisition frequency F of the images by the cameras.

Each bispectral mega-image MIB has a dimension of 2×M×N pixels, where N is the total number of pixels of an image in a band of a camera (N=L×H).

This plurality of bispectral mega-images forms a unique signal at the frequency F.

That signal is used by the processing means 16, 18, 20 simultaneously so as to generate at least two pieces of information among imaging, watch, and early threat information during steps 108, 110, and 112, respectively.

The step 108 for generating imaging information implemented by the means 20 for generating steering information will now be outlined.

The imaging information comprises a mega-image with a high spatial resolution formed from images from each camera having a resolution of 1000 pixels×1000 pixels.

This step 108 includes a sub-step 114 for generating a mega-image having an impression of depth by combining the images acquired in the red band and the blue band.

A measurement of the distance of the objects present in the image is done as described in patent EP 0 759 674 by comparing the image obtained in each band. The exploitation of the bispectral images to assess the distance is unchanged relative to that described in the aforementioned document. The red band is chosen so as to be partially absorbed. In the case of the 3-5 μm band, for a natural object (black body or sun glint), the blue band is not very absorbed by the carbon dioxide, while the red band undergoes a variable effect with the distance. The comparison of the signals from the two bands makes it possible to estimate the distance.

The ratio of the intensity of each pixel of the image in the red band and the blue band is calculated. The ratio depends on the atmospheric transmission, which depends on the distance of the imaged object on the pixel. FIG. 5 is an example of atmospheric transmission, in the spectral bands situated on either side of 4.5 μm between 3 and 5 μm, for two different distances.

Then, during a step 116, an image is displayed by the screen 7. This image is either the image having an impression of depth resulting from the step 108, or the image of one or the other band as a function of the meteorological conditions.

In fact, it is known that in cold climates, the image acquired in the red band, for example with wavelengths larger than 4.5 μm, is generally better than that obtained in the blue band, with wavelengths for example below 4.5 μm.

The step 110 for generating watch information implemented by the means 16 for generating watch information will now be outlined.

The watch consists of searching for and detecting targets and tracking them, i.e. watching their movement by measuring their position over time.

In a known manner, the objects or targets to be watched have a quasi-periodic size on the images and evolve relatively slowly over time.

As a result, radiometric contrast is crucial on the images so as to detect a target and deduce the watch information therefrom, which is why preferably, bispectral images are used with minimum dimensions of 1000 pixels×1000 pixels produced by the camera(s).

The step 110 includes a sub-step 117 for detecting radiometric contrast using the means 16 for generating watch information. During this sub-step, the intensity of each pixel is compared to the intensity of a pixel representative of the background of the image, i.e., a normal environment. The pixels representative of the potential target have an intensity different from that of the background for at least one of the two bands.

Then, during a step 118, the means 16 for generating watch information identify the target(s) by their respective spectral signatures, by comparing the images produced in each of the bands.

To that end, the intensities of the pixels are compared in the two bands, pixel by pixel or group of pixels by group of pixels. This comparison for example makes it possible to assess the apparent temperature of the target, and therefore to deduce an object class therefrom (person, tank, etc.).

For example, an object whereof the radiation in the two bands follows the laws of black bodies is probably a natural object.

Then, tracking of each target is generated during a step 120, i.e. monitoring of the position of the target. The tracking is done on at least one plurality of images acquired in a same band.

For example, a target may be detected in a so-called “sensitive band,” but not in the other band, which is then called a “blind band.” This non-detection in the blind band and the value of the light intensity emitted by the target in the sensitive band forms identification elements of the target.

To estimate the radiation in the blind band, the detections done in the sensitive band are then used to identify the pixels of the point where the target is located and thereby obtain the spectral signature information in that band.

Furthermore, the tracking of the targets generated in each band is complementary.

For example, a target is detected in the first band during a first period T1, then in the second band during a second period T2 following T1. In that case, the tracking is preferably done in the first band during T1, then in the second for the period T2.

Then, the step 112 for generating threat information implemented by the means 18 for generating threat information is carried out so as to determine whether the target is a threat. This step 112 will now be outlined.

Early threat information comprises the detection of the beginning of that threat, i.e. a brief emission or an emission having a time signature characteristic of a type of threat (related to the propulsion of the threat). To generate that information, it is particularly important to have both radiometric sensitivity and a high time response.

Thus, the processing to generate early threat information is done on images having dimensions at least equal to 500 pixels×500 pixels and delivered at a rate of at least 400 Hz.

The step 112 comprises a sub-step 122 for searching for a signature for radiometric contrast, then a spectral signature followed by a sub-step 124 for searching for a time signature and discriminating the type of threat. As previously described, an intensity different from that of the background for a pixel constitutes a radiometric signal and is associated with a potential threat. In the case of a flame or a jet, the intensity is higher than that of the background.

During the sub-step 122, the images coming from the two red Sr and blue Sb bands are combined, so as to distinguish the threats from the bright points caused by sun glint by comparing the radiation in the two sub-bands.

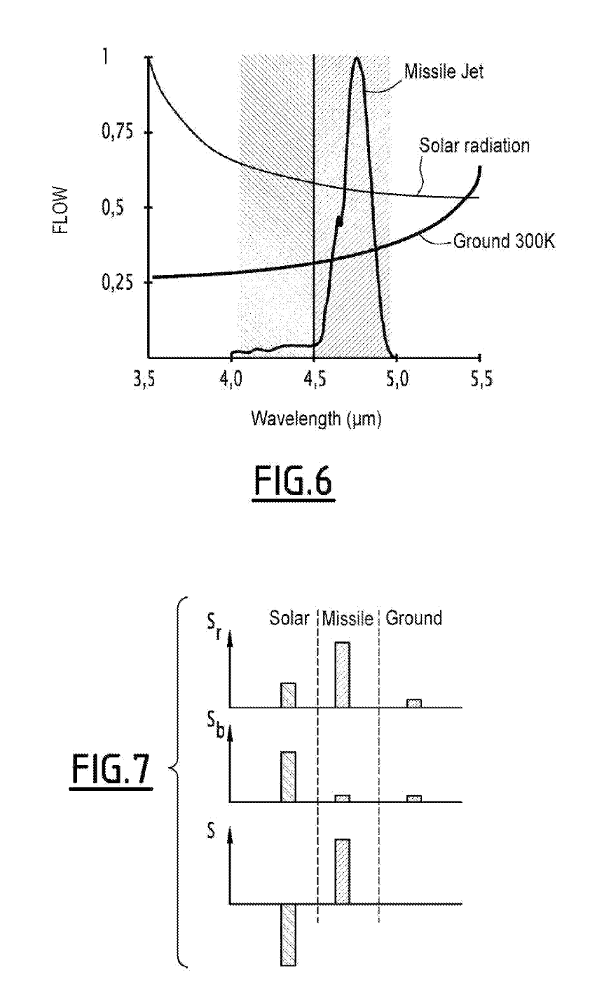

In light of FIGS. 6 and 7, each image Sr, Sb in the infrared spectral band comprised between 3 and 5 μm is the result of the light emission of three contributions: the ground, the solar radiation, and the missile jet if the missile is launched or the flash if ammunition is fired.

The purpose of combining the two images Sr and Sb is to cancel the contribution of the background in the two sub-bands.

To that end and in a known manner, for each pixel, a quantity S is calculated using the formula S=Sr−A.sb by adjusting the parameter A. The parameter A is generally chosen for all of the pixels of the image.

A positive signal S reveals a missile jet or a flash. A negative signal S corresponds to sun glint and a zero signal at the ground.

One advantage of this method is that the likelihood of false alarms for the detection of missiles is decreased relative to the use of mono-spectral cameras. In fact, the combination of these bands makes it possible to do away with sun glint and distinguish the emission of the missile from natural sources, unlike a mono-spectral imaging system. For such a mono-spectral device, it is easy to detect the “hot” pixels, i.e., those with a high intensity; nevertheless, it is difficult to differentiate whether they are associated with an early threat or sun glint on a surface.

This also makes it possible to determine the direction of the potential threats.

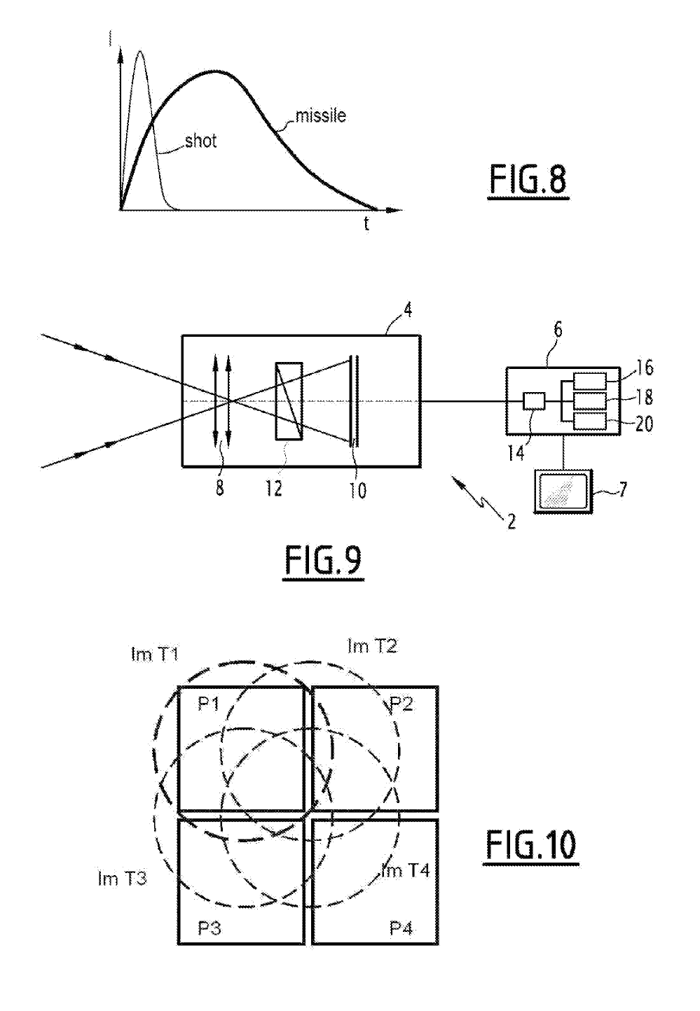

Then, during the step 124 and light of FIG. 8, the light intensity of these pixels, identified as possible threats, is watched over time in one or both bands. The time profile of the light intensity subsequently makes it possible to discriminate the type of threat, using what is called their time signature.

For example, a shot has a very short emission, in the vicinity of a millisecond, relative to missiles, which are thus detected by the emission of their jet or flame, whereof the emission is long, in the vicinity of several seconds.

Furthermore, it is possible to perform tracking, as in step 120, so as to watch the threat, for example to watch the travel of a missile.

The watch and threat information is then displayed on the screen 7.

For example, the threat is indicated on the image having an impression of depth produced in step 114 and displayed on the screen during step 7. Furthermore, the path of a target is displayed by superposition on that same image.

According to a second embodiment of the imaging device 2 shown in FIG. 9, the detector of the or each bispectral camera 4 has a minimum dimension of 500 pixels×500 pixels. In a known manner, this device makes it possible to improve the image designed for observation to the detriment of the time resolution.

Furthermore, the bispectral camera 4 includes a micro-sweeping system 12, for example like that described in patent EP 0 759 674.

The micro-sweeping is done over a plurality k of consecutive positions, and preferably over at least 4 positions.

For example, the micro-sweeping system is of the rotary prism type.

In light of FIG. 10, one example of micro-sweeping with four positions is illustrated by the movement in four successive positions denoted Im T1 to Im T4 of the image of a periodic object over four adjacent pixels denoted P1 to P4 of the detector 10.

For example, a bispectral matrix with dimensions of 500 pixels×500 pixels and an acquisition frequency of 400 Hz then generates 400 frames per second, each with dimensions 500 pixels×500 pixels. An image comprises the four consecutive bispectral frames generated by the micro-sweeping.

It is known that a micro-sweeping device makes it possible to generate additional pixels and therefore to improve the sampling of the image and to increase its resolution.

Thus, each bispectral image reconstructed after micro-sweeping has a dimension of 1000 pixels×1000 pixels×2 spectral bands.

Furthermore and also in a known manner, the micro-sweeping makes it possible to perform non-uniformity corrections (NUC).

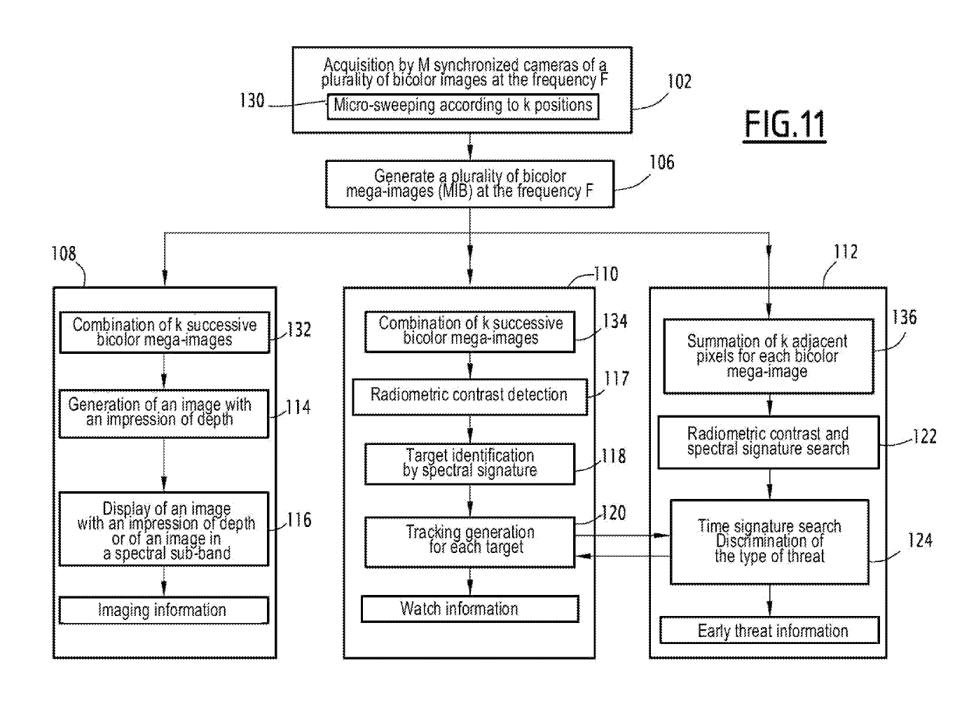

Another embodiment of the method will now be described in light of FIG. 11. This embodiment is designed to be implemented by an imaging device comprising a micro-sweeping device as shown in FIG. 9. The steps identical to the previous embodiment bear the same references and are not outlined below.

The step 102 for acquiring a plurality of bispectral images using M cameras comprises a micro-sweeping sub-step 130 according to a plurality k of positions of the pixels of the detector. Thus, the optical flow sweeps each pixel of the matrix of the detector according to a plurality k of positions using the micro-sweeping system 12. Preferably, k is equal to 4.

The k positions of the sweeping of the optical flow thus generate k frames shifted on the matrix of photodetectors forming an image.

At the end of step 102, a plurality of bispectral images of k bicolor frames are generated at the frequency F.

Each frame of the band has dimensions of at least 500 pixels×500 pixels.

Then, the images resulting from the micro-sweeping and with two spectral bands are processed differently according to the information to be generated.

The step 108 for generating imaging information comprises a sub-step 132 for combining k successive bicolor mega-images before generating an image having an impression of depth in step 114. This sub-step 132 is carried out by means for combining the plurality of bicolor mega-images of the processing means 6 of the imaging device 2.

In this way, the pixels of k successive frames of an image are combined so as to generate an over-sampled image therefore having a better resolution. This image is then produced at a slower frequency.

For example, an imaging device having a bicolor camera where the matrix has a dimension of 500 pixels×500 pixels, an acquisition frequency of 400 Hz and comprising a micro-sweeping device with 4 positions will make it possible to generate images in each spectral band with a resolution of 1000 pixels×1000 pixels at the frequency of 100 Hz.

This time resolution is sufficient to display imaging information, for example to assist with steering, which requires a time resolution at least equal to that of the human visual system.

Likewise, the step 110 for generating watch information comprises a sub-step 134 identical to the sub-step 132 before carrying out the steps 117 and 118 for detecting a radiometric contrast and identifying targets by spectral signature.

According to one alternative, these sub-steps are shared and carried out by shared processing means for processing the plurality of bispectral mega-images with the means 16 and 20 so as to decrease the processing time for the images.

Lastly, the step 112 for generating threat information comprises a sub-step 136 for adding k adjacent pixels for each bispectral mega-image before carrying out the step 122 for searching for a radiometric contrast and spectral signature.

The purpose of this sub-step 136 is to improve the spatial resolution of the images. This is done by computation means integrated into the processing means 6 of the imaging device 2.

In fact, the micro-sweeping dilutes the signal caused by the emission of a periodic object. For example, in FIG. 3, during the acquisition of the image Im T4, the signal is shared between the 4 pixels P1, P2, P3 and P4.

In order to avoid this effect, the signatures of 4 adjacent pixels are added for each image of the same frame, the set of 4 pixels seeing, at each moment, practically all of the signal emitted by a point.

In the preceding example, one thus generates a plurality of images at 400 Hz of bispectral frames whereof the image in a band has dimensions of 500 pixels×500 pixels. In this way, the spatial resolution of an image is decreased by two, but at least one of the pixels contains the entire signal.

Step 122 for searching for the spectral signal is then carried out on that frame.

In this embodiment of the method, the images or signals generated during the micro-sweeping step are exploited differently and optimally according to the sought information.

The method according to the invention thus makes it possible to generate, simultaneously and using a same device, at least two pieces of information from amongst:
very wide field imaging information useful for navigation, steering, etc.,
watch information, and
early threat detection information (shots, missile, cannon, etc.).

One advantage of the multifunctional imaging system according to the invention is the reduced number of detectors and means necessary to perform all of the considered functions, and therefore the reduction in costs of the entire system and of integration into a platform.

Other advantages include better performance of the functions performed by the bispectral cameras relative to model spectral cameras, improved discrimination for the watch and threat detection functions, and an impression of relief/depth in the images that is extremely useful in steering or navigation.

The invention is not limited to the example embodiments described and shown, and in particular may be extended to other bands of the infrared band or other spectral bands, for example in the 8-12 μm band.

What is claimed is:

1-9. (canceled)

10. A multifunctional bispectral imaging method comprising the steps of:
acquiring a plurality of bispectral images (IB_{M}), each bispectral image being the combination of two images (IM₁, IM₂) acquired in two different spectral bands;
generating a plurality of images, each image giving an impression of depth by combining the two images acquired in the two different spectral bands, the plurality of images being imaging information;
processing, simultaneously, the plurality of bispectral images to generate, in addition to the imaging information, watch information or early threat information, the processing including the steps of:
searching for specific spectrum and time signatures in the plurality of bispectral images, a particular spectral and time signature being associated with a particular threat; and
detecting a specific object in each bispectral image, and generating a time-tracking of the position of the object in the plurality of images in each spectral band, the detecting and the tracking of the object forming the watch information.

11. The method according to claim 10, wherein the two different spectral bands belong to a same infrared spectral band whereof the wavelength is between 3 and 5 μm and the two different spectral bands are each situated on either side of a wavelength substantially equal to 4.3 μm.

12. The method according to claim 10, wherein the step of acquiring a plurality of bispectral images is carried out at a high frequency, the high frequency being at least equal to 400 Hz.

13. The method according to claim 1, wherein the step of acquiring a plurality of bispectral images includes a micro-sweeping step to generate a plurality of higher resolution bispectral images.

14. The method according to claim 4, further comprising a step of combining a plurality of pixels of each higher resolution bispectral image to reduce the number of pixels and improve the signal-to-noise ratio before the searching for specific spectrum and time signatures step.

15. The method according to claim 1, wherein the plurality of bispectral images is acquired by at least two cameras that are time synchronized beforehand.

16. The method according to claim 11, wherein the step of acquiring a plurality of bispectral images is carried out at a high frequency, the high frequency being at least equal to 400 Hz.

17. The method according to claim 16, wherein the step of acquiring a plurality of bispectral images includes a micro-sweeping step to generate a plurality of higher resolution bispectral images.

18. The method according to claim 17, further comprising a step of combining a plurality of pixels of each higher resolution bispectral image to reduce the number of pixels and improve the signal-to-noise ratio before the searching for specific spectrum and time signatures step.

19. The method according to 16, wherein the plurality of bispectral images is acquired by at least two cameras that are time synchronized beforehand.

20. The method according to 17, wherein the plurality of bispectral images is acquired by at least two cameras that are time synchronized beforehand.

21. The method according to 18, wherein the plurality of bispectral images is acquired by at least two cameras that are time synchronized beforehand.

22. The method according to claim 11, wherein the step of acquiring a plurality of bispectral images includes a micro-sweeping step to generate a plurality of higher resolution bispectral images.

23. The method according to claim 22, further comprising a step of combining a plurality of pixels of each higher resolution bispectral image to reduce the number of pixels and improve the signal-to-noise ratio before the searching for specific spectrum and time signatures step.

24. The method according to 22, wherein that the plurality of bispectral images is acquired by at least two cameras that are time synchronized beforehand.

25. The method according to 23, wherein that the plurality of bispectral images is acquired by at least two cameras that are time synchronized beforehand.

26. An imaging device comprising:
at least one bispectral camera, each camera including a bispectral matrix of a plurality of detectors capable of acquiring a plurality of bispectral images, each bispectral image being the combination of two images acquired in two different spectral bands,
an imaging device generating a plurality of images, each of the plurality of images giving the impression of depth from the two images acquired in the two different spectral bands, the plurality of images being imaging information, and
a processor for simultaneous processing operations of the plurality of bispectral images to generate at least two pieces of information from amongst watch information, early threat information, and imaging information, the processor being connected to the at least one bispectral camera, the processor generating the imaging information, the processor searching for specific spectrum and time signals from the plurality of bispectral images, a particular spectral and time signature being associated with a particular threat and the processor detecting a particular object on each bispectral image and generating a time-tracking of the position of the object on the plurality of images in each spectral band, the detection and tracking of the object forming the watch information.

27. The imaging device according to claim 26, wherein the two bands belong to a same infrared spectral band whereof the wavelength is between 3 and 5 μm and he two different spectral bands are each situated on either side of a wavelength substantially equal to 4.3 μm.

28. An imaging device comprising:
at least one bispectral camera, each including a bispectral matrix of a plurality of detectors capable of acquiring a plurality of bispectral images, each bispectral image being the combination of two images acquired in two different spectral bands;
an imaging device generating a plurality of images each giving the impression of depth from the two images acquired in the two different bands, the plurality of images being imaging information; and
a processor for simultaneous processing operations of the plurality of bispectral images to generate at least two pieces of information from amongst watch information, early threat information, and imaging information, the processor being connected to the at least one bispectral camera, the processor:
generating the imaging information;
searching for particular spectral and time signals from the plurality of bispectral images, a particular spectral and time signature being associated with a particular threat; and
detecting a particular object on each bispectral image and generating a time-tracking of the position of the object on the plurality of images in each spectral band, the detection and tracking of the object forming the watch information
the imaging device performing the method recited in claim 10.

29. The imaging device according to claim 28, wherein the two bands belong to a same infrared spectral band whereof the wavelength is between 3 and 5 μm and he two different spectral bands are each situated on either side of a wavelength substantially equal to 4.3 μm.
